(19) United States
(12) Patent Application Publication
(10) Pub. No.: US 2008/0103018 A1
(43) Pub. Date: May 1, 2008

(54) System for Identifying Position of Locking Differential

(76) Inventors: Brent Michael Peura, Farmington, MI (US); Robert Genway-Haden, Rochester Hills, MI (US)

Correspondence Address: Dickinson Wright PLLC, 38525 Woodward Avenue, Suite 2000, Bloomfield Hills, MI, 48304, US

(21) Appl. No.: 11/662,843

(22) PCT Filed: Sep. 16, 2005
(86) PCT No.: PCT/US05/33202

§ 371 Date: Mar. 14, 2007

Related U.S. Application Data
(60) Provisional application No. 60/611,019, filed on Sep. 17, 2004.
(60) Provisional application No. 60/610,663, filed on Sep. 17, 2004.

(51) Int. Cl. B60K 23/04; G06F 7/00

(52) U.S. Cl. 477/35; 701/36

(57) ABSTRACT

The application aims at determining the locked or unlocked state of a differential (10). According to a first aspect, the determination is carried out on basis of a speed difference of output shafts (16, 18) using speed sensors (36, 38). Steering angle may be used as further input. In a second aspect, a sensing system (70) senses actuating pressure, voltage or current of an actuating mechanism (44). In a third aspect, the first and second aspects can be combined.

### CROSS REFERENCE TO RELATED APPLICATIONS

This application claims priority to U.S. Provisional Patent Application Ser. No. 60/610,663, filed on Sep. 17, 2004 and U.S. Provisional Patent Application Ser. No. 60/611,019, filed on Sep. 17, 2004.

### TECHNICAL FIELD

The present invention generally relates to a locking differential, and more particularly, the present invention relates to a locking differential having a feedback system for determining when the locking differential is in a locked or unlocked state.

### BACKGROUND OF THE INVENTION

Conventional locking differentials transmit rotational energy between one input shaft and at least one output shaft. In one common locking differential used in vehicles, one input shaft provides rotational energy to two output shafts. In such an arrangement, the input shaft, otherwise known as a propshaft, transmits rotational energy from the vehicle engine to the output shafts through a gear set located within a housing of the differential. The output shafts are then connected to either the front or rear vehicle wheels.

As will be readily understood by one skilled in the art, the gear set in the differential includes spider gears connected to the housing, and drive gears connected to the output shafts. Rotational energy from the propshaft drives a ring gear attached to the housing, which in turn transmits the rotational energy through the spider and drive gears to the output shafts.

The arrangement described above not only transmits rotational energy to the output shafts, but also allows one output shaft to rotate at a different speed than the other. Primarily, as will be understood by one skilled in the art, this difference in speed is a result of the interrelationship between the spider gears, housing and the drive gears. Allowing one output shaft to rotate at a different speed than the other allows a vehicle using this system to have dramatically increased steering and control as compared to a vehicle not having such an arrangement.

In certain instances, however, it is desirable to lock one output shaft to the other, such that both shafts rotate at the same speed. Such an arrangement has specific advantages for vehicles traveling over rough terrain, as is common with off-road conditions. However, as this locked arrangement is needed only some of the time, it is desirable to provide a selective locking and unlocking state for the differential. One way to implement this selective locking arrangement is to provide an actuated locking mechanism that locks one output shaft to the other, such that both shafts rotate at the same speed when in a locked state. Such a locking mechanism typically includes a drive cam and driven cam arrangement that is engaged by a pneumatic, hydraulic or electrically actuated mechanism. The drive cam connects to one output shaft while the driven cam connects to the other output shaft. The actuated mechanism selectively drives the drive cam into the driven cam to rigidly connect the drive cam to the driven cam and therefore one output shaft to the other.

As discussed above, however, it is desirable to ensure that the output shafts are unlocked during a particular set of driving conditions and locked during another set of driving conditions. If the wrong state is engaged for the wrong driving conditions, driving inefficiencies or other problems could occur.

To indicate the locking state or to properly warn of an incorrect or undesirable locking state, a system has been devised to sense when the differential is in a locked or unlocked state. Such a system, conventionally, includes a limit switch attached to the drive cam that moves with the drive cam between its locked and unlocked positions. Movement of the drive cam and therefore the switch, electrically communicates the drive cam position back to a signal light or other feedback device to indicate the position of the drive cam as being either in the locked or unlocked position.

While this system senses whether the differential is in a locked or unlocked state, certain drawbacks may exist. To sense the locked state of the differential, the system described above requires a switch attached directly to the actuating device or drive cam, as well as an electrical connection passing back to either an electronic control unit, signal light or other feedback device. As such, this system tends to be expensive and cumbersome. The present invention is directed towards addressing these and other potential drawbacks.

### SUMMARY OF THE INVENTION

A system is provided for determining when a differential is in a locked or unlocked state. The system includes at least a first speed sensor adapted to determine a speed of a first output shaft of the differential and a second speed sensor adapted to determine a speed of a second output shaft of the differential. A circuit is provided that is responsive to the first speed sensor and a second speed sensor to determine whether a difference in rotational speed between the first output shaft and the second output shaft is within a predetermined range.

A system is also provided for determining when a differential is in a locked or unlocked state. The system includes an actuating mechanism engaged to a drive cam of the differential that is adapted to move the drive cam between a locked and unlocked position. A sensing system is provided that is adapted to sense source characteristics to the actuating mechanism to determine whether the drive cam is in the locked or unlocked position.

Other advantages and features of the invention will become apparent to one of skill in the art upon reading the following detailed description with reference to the drawings illustrating features of the invention by way of example.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 is a schematic view of a system according to an aspect of the present invention.

FIG. 2 is a schematic view of a system according to an aspect of the present invention in a vehicle application.

FIG. 3A is a detail view of III in FIG. 1 according to an aspect of the present invention.

FIG. 3B is a detail view of III in FIG. 1 according to an aspect of the present invention.

FIG. 4 is a schematic view of a system according to an aspect of the present invention.

FIG. 5 is a schematic view of a system according to an aspect of the present invention.

FIG. 6 is a graphical view of a system according to an aspect of the present invention.

FIG. 7 is a graphical view of a system according to an aspect of the present invention.

FIG. 8 is a graphical view of a system according to an aspect of the present invention.

FIG. 9 is a graphical view of a system according to an aspect of the present invention.

### DETAILED DESCRIPTION OF THE DRAWINGS

The feedback system according to an aspect of the present invention senses output speeds from the output shafts of the differential to determine whether the output shafts are rotating at same or different speeds. From this information, the feedback system determines whether or not the differential is in a locked or unlocked state. In one embodiment, rotational speed sensors engaged with the output shafts sense the output speeds of the shafts. The rotational speed sensors may be sensors used in connection with an existing antilock braking system of the vehicle. Additionally, in other embodiments, other sensors including, but not limited to, yaw, acceleration and steering wheel position may be used to provide additional information to compensate for abnormal driving conditions.

The feedback system according to a further aspect of the present invention senses power source information such as hydraulic, pneumatic, electric or other source information to determine the locked state of the differential.

While the present invention is described with regard to a system for sensing the locked or unlocked state of a vehicle differential, it can be adapted and utilized for other locking shaft drive arrangements, including those outside of the automotive field.

In the following description, various operating parameter and components are described for several embodiments. These parameters and components are included as examples and are not meant to be limiting.

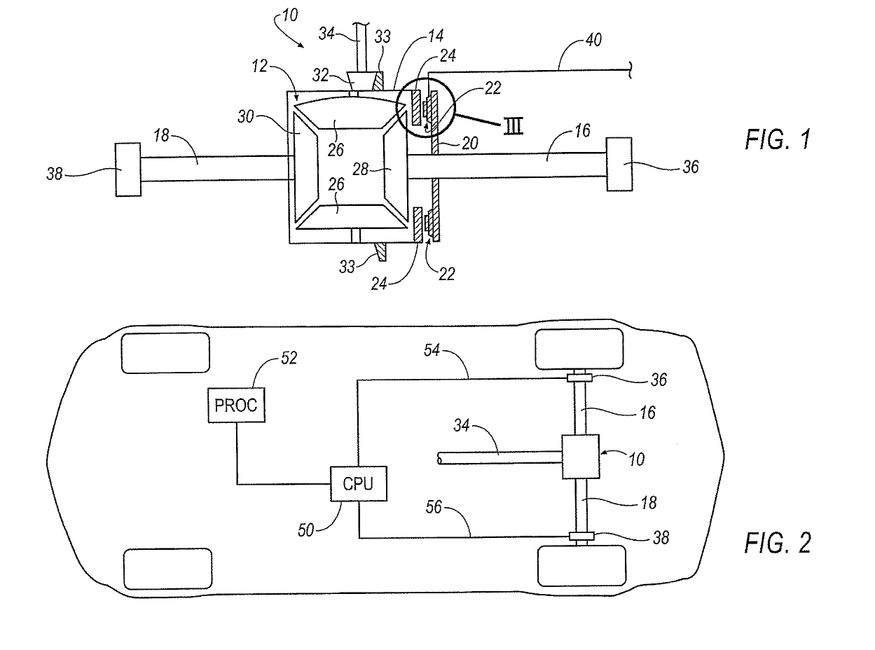

Referring now to FIG. 1, an aspect of the feedback system according to an embodiment of the present invention is shown and described. FIG. 1 includes an exemplary embodiment of a locking differential 10. It should be noted that the embodiment of the locking differential 10 shown in FIG. 1 is merely one example of a differential, and the present invention may be used with any locking differential mechanism as will be readily understood by one skilled in the art.

The locking differential 10 has a gear set 12 encapsulated in housing 14. The gear set 12 generally includes spider gears 26 that mesh with a first drive gear 28 and a second drive gear 30. As noted above, the example shown in FIG. 1 is merely one example of a differential. Accordingly, other variations of the gear set 12 may be used in conjunction with the differential 10 other than that shown in the Figure. For example, the gear set 12 may include only one spider gear 26.

A first output shaft 16 extends from one side of the housing 14 while a second output shaft 18 extends from another side of the housing 14. The first output shaft 16 is connected to the first drive gear 28 such that the first output shaft 16 and drive gear 28 rotate in unison. Likewise, the second output shaft 18 is connected to second drive gear 30 such that the second output shaft 18 and second drive gear 30 rotate in unison.

The housing 14 may be connected to the rotational centers of the spider gears 26 as shown. Through this connection, rotation of the housing 14 about the axes of first output shaft 16 and second output shaft 18 causes a similar rotation of the spider gears 26. A ring gear 33 is located at an outer portion of the housing 14. The meshing arrangement between the pinion gear 32 of the input shaft 34 provides the rotational energy to rotate the housing 14 about the axial centers of the output shafts 16, 18. A driven cam 24 is located at a first side of the housing proximate the first output shaft 16. The driven cam 24 is described in greater detail below. A second side of the housing 14 is connected to the second output shaft 18.

A first rotational speed sensor 36 is operatively associated with the first output shaft 16 to measure a rotational speed of the first output side of the differential which, in this example, is the first output shaft 16. Likewise, a second rotational speed sensor 38 is operatively associated with the second output shaft 18 to measure the rotational speed of the second output side of the differential which, in this case, is the second output shaft 18. The first and second rotational speed sensors 36, 38 output first and second speed signals, respectively. It should be noted that first rotational speed sensor 36 and second rotational speed sensor 38 may be any conventional speed sensor and may be located at any point along the output shafts or elements, such as wheels, connected to the output shafts. In one embodiment, the rotational speed sensors 36 and 38 are wheel speed sensors which form part of an antilock braking system. For example, the speed sensors can include a magnetic pickup and a toothed sensor ring. The sensors 36, 38 may be mounted in the steering knuckles, wheel hubs, brake backing plates, transmission tailshaft or differential housing. On some applications, sensors 36, 38 can be an integral part of the wheel bearing and hub assembly. The sensor rings may be mounted on the axle hub behind the brake rotor, on the brake rotor itself, inside the brake drum, on the transmission tailshaft or inside the differential on the pinion shaft.

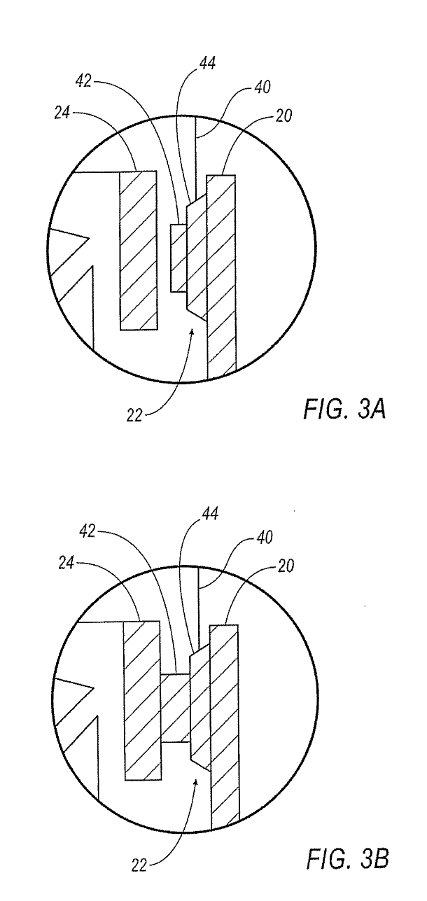

Engagement plate 20 is affixed to first output shaft 16 such that it rotates with the output shaft 16. The engagement plate 20 may include a circumferential ring that rotates with the output shaft 16. A drive cam 22 may be disposed at an outer portion of the engagement plate 20. As shown in the detailed embodiment illustrated in FIGS. 3A and 3B, the engagement plate 20 and drive cam 22 may include an engagement portion or segment 42 and an actuating mechanism 44. The actuating mechanism 44 responds to the supply 40 to drive the engagement portion or segment 42 into the driven cam 24 as shown in FIG. 3B. It should be noted that the Figures are merely schematic views, and that many numerous different configurations from that shown may be used. For example, actuating mechanism 44 may be a solenoid, pressure plate actuation device, hydraulic actuated device, pneumatic actuated device or other known means of actuation. The engagement between engagement portion or segment 42 and driven cam 24 may be through meshed gears, friction plate arrangement, or any other known means of engaging two moving surfaces. Moreover, the engagement plate 20 need not be circumferential and instead may be any other configuration suitable for this purpose.

When the engagement portion or segment 42 and driven cam 24 are coupled, the rotational speed of first output shaft 16 is tied to the rotational speed of the housing 14. As the housing 14 is connected to the second output shaft 18, which ties the rotational speed of the housing 14 to the output shaft 18, the rotational speed of the first output shaft 16 is tied to the rotational speed of the second output shaft 18. Therefore, when the engagement portion or segment 42 and driven cam 24 are coupled, the differential 10 is in a locked state. Likewise, when the engagement portion or segment 42 and driven cam 24 are uncoupled, then the differential 10 is in an unlocked state.

As shown in FIG. 2, the first rotational sensor 36 has an output 54 to a computing circuit, such as for example, controller 50 that indicates the rotational speed of first output shaft 16. Likewise, second rotational sensor 38 has an output 56 that indicates the rotational speed of second output shaft 18 to a computing circuit, e.g., controller 50. From these two signals reporting the rotational speeds of the output shafts, controller 50 can calculate the difference in rotational speed between the first output shaft 16 and the second output shaft 18. It should be noted that the controller 50 may take a time weighted average of the outputs from the first rotational sensor 36 and the second rotational sensor 38 to compensate for small variations not attributable to the locked or unlocked state of the differential 10. When the difference in rotational speeds is within a predefined range, controller 50 determines that the differential 10 is in a locked condition. Likewise, when the difference in rotational speed is outside a predetermined range, controller 50 determines that the differential 10 is not in a locked condition. In response, the controller 50 may perform a number of desired or optional functions alone or in combination. If desired, the controller 50 can instruct a gauge or signal light to indicate that the differential is in one state or another, The controller may compare its determined state with that from another source, such as a selector switch, to determine whether the differential is in the correct state.

Controller 50 ca be a microprocessor-based controller which provides integrated control of the vehicle powertrain. Of course, the controller 50 may also be implemented in a separate controller depending upon the particular application. For purposes of determining the locked or unlocked state of the differential 10, controller 50 may be a comparator circuit. However, in other applications, controller 50 may comprise a microprocessor in communication with input ports, output ports, and computer readable media via a data/control bus. Computer readable media may include various types of volatile and nonvolatile memory such as random access memory (RAM), read-only memory (ROM), and keep-alive memory (KAM). These “functional” descriptions of the various types of volatile and nonvolatile storage may be implemented by any of a number of known physical devices including but not limited to EPROMs, EEPROMs, PROMs, flash memory, and the like. Computer readable storage media includes stored data representing instructions executable by the microprocessor to implement the method for determining the locked or unlocked state of the differential according to the present invention or stored values for comparing with sensed values. The microprocessor communicates with the various sensors 36, 38 and actuators via an input/output (I/O) interface.

In another embodiment of the present invention, sensors 52 may provide separate or additional input to controller 50. Here, sensors such as yaw, steering wheel position, acceleration sensors (e.g. G sensors) or other sensors provide separate or additional information to the controller 50. Specifically, under certain turning or acceleration situations, it is possible for first output shaft 16 to rotate at a speed different from the second output shaft 18 by an amount greater than the predefined range. As such, sensors 52 provide additional input to the controller 50 to indicate when such turning or acceleration situations exist. In response, controller 50 compensates its calculations based on its conclusions as to its calculated difference between the rotational speeds of the output shafts.

Thus, in operation, the controller 50 determines the first speed sensor output and second speed sensor output. If the sensed rotational speeds are approximately equal, i.e., are within a predetermined range of difference values, the controller outputs a response indicating a locked state of the differential. This output can be confirmed by input from other sensors 52 when such sensors 52 indicate, for example, straight line travel by the vehicle.

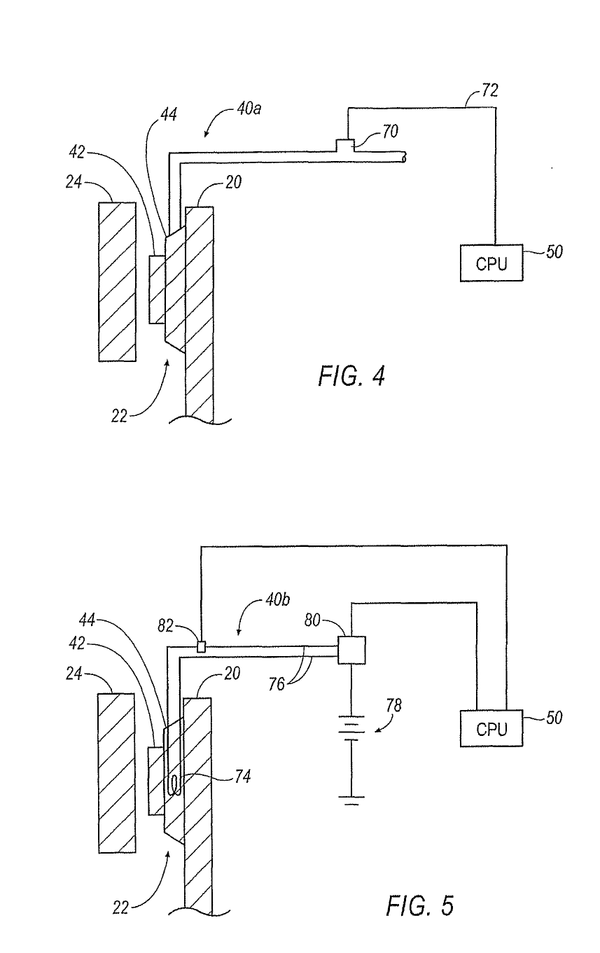

In FIG. 4, the actuating mechanism 44 is shown as a pneumatic or hydraulic activated mechanism. As such, the supply to actuating mechanism 44, shown in FIG. 4 as supply 40a, is either a hydraulic or pneumatic source. A pressure or flow switch 70 is disposed along the supply 40a to measure either pressure or flow. In response to the measured characteristic by pressure or flow switch 70, a representative signal of the measured pressure or flow is sent through connection 72 back to controller 50. It should be noted that pressure or flow switch 70 may be an independent pressure switch or an independent flow switch. For purposes of these examples, however, the switch is shown as a pressure and flow switch. This signal can provide additional or alternative confirmation of the state of the differential.

Referring now to FIG. 5, another aspect of the present invention is shown and described. In FIG. 5, the actuating mechanism 44 is shown as a solenoid device. Specifically, the coil 74 is supplied current through leads 76 from voltage source 78. The switching circuit 80 provides current flow in different directions, responsive to input from controller 50, depending on whether the actuating mechanism 44 is moving the engagement portion or segment 42 toward or way from driven cam 24. Voltage or current sensor 82 senses either voltage or current provided through leads 76 or at any other area in the overall circuit that supplies power to coil 74. Again, this provides an additional or alternative feedback mechanism to the controller 50 as to the state of the differential.

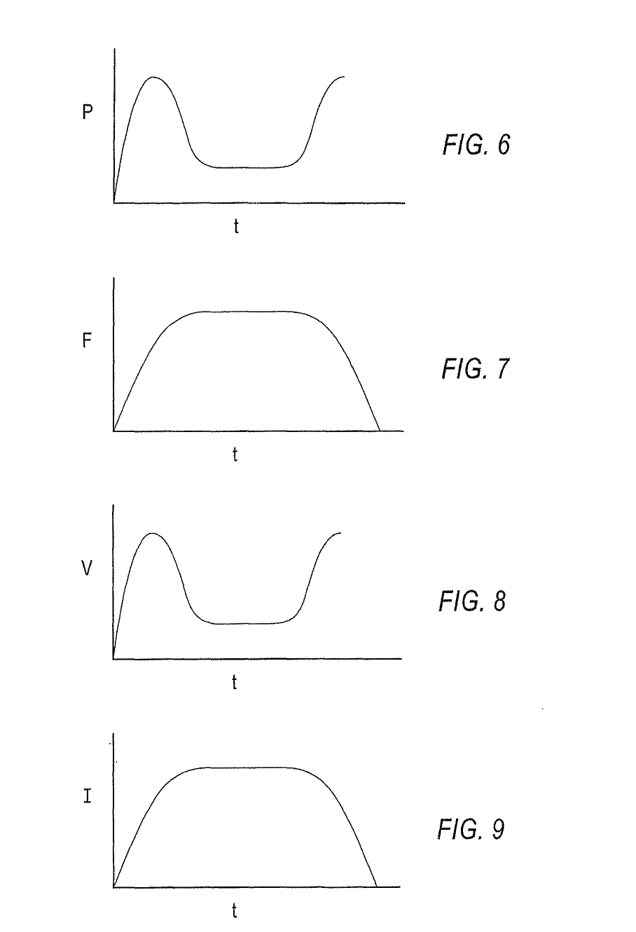

Referring now to FIGS. 3A, 3B, 6 and 7, the operation of the present invention is shown and described. The graphical view in FIG. 6 represents the sensed pressure and the graphical view in FIG. 7 represents the sensed flow, with respect to time, by pressure or flow switch 70 when the actuating mechanism 44 moves the engagement portion or segment 42 from that shown in FIG. 3A to that shown in FIG. 3B or vice versa. In FIG. 6, the pressure begins at a higher level, drops to a lower level while the engagement portion or segment 42 moves, and then again returns to a high level when the engagement portion or segment 42 stops moving. Conversely, in FIG. 7, the flow begins at a low level when the engagement portion or segment 42 begins to move, goes to a higher flow rate while the engagement portion or segment 42 moves, and ends at a lower flow rates when the engagement portion or segment 42 stops moving again.

Depending on whether pressure or flow is monitored by the controller 50, the controller 50 can compare a proper pre-stored pressure or flow curve with that actually measured to determine whether or how far the engagement portion or segment 42 has moved. Accordingly, from the sensed information, the controller 50 is able to determine whether the differential 10 is in a locked or unlocked state. This may be accomplished by monitoring the feedback signal value change over time, or by comparing the feedback signal value for a lockup table of values stored in memory.

Referring now to FIGS. 3A, 3B, 8 and 9, the operation of the present invention shown in FIG. 5 is described. FIG. 8 represents the voltage and FIG. 9 represents the current, per unit time, provided to actuating mechanism 44 when engagement portion or segment 42 travels from that shown in FIG. 3A to FIG. 36 or vice versa. Similar to FIG. 6, the voltage initially peaks when the engagement portion or segment 42 begins to move, drops during movement of the engagement portion or segment 42, and then peaks again when the engagement portion or segment 42 stops moving. Similar to FIG. 7, the current initially has minimal flow when the engagement portion or segment 42 begins to move, has increased flow during movement, and return to minimal flow when the engagement portion or segment 42 stops moving again.

From this information, controller 50 can compare a proper pre-stored voltage or current curve with that actually measured to determine if or how far the engagement portion or segment 42 has moved. Accordingly, from the sensed information, the controller 50 is able to determine whether the differential 10 is in a locked or unlocked state.

Other configurations from that described above are possible as well. For example, the aspects disclosed in FIGS. 6 and 7 can be combined with that of FIGS. 8 and 9. Specifically, the voltage or current may be monitored to a pneumatic or hydraulic pump in a similar fashion to determine the locked or unlocked state. Additionally, portions or different electric, pneumatic or hydraulic characteristics may be monitored to identify the locked or unlocked state of the differential.

While the invention has been described in connection with several embodiments, it should be understood that the invention is not limited to those embodiments. Thus, the invention covers all alternatives, modifications, and equivalents as may be included in the spirit and scope of the appended claims.

What is claimed is:

1. A system for determining the locked or unlocked state of a differential, comprising:
a first speed sensor operatively associated with a first output side of the differential, and outputting a first speed signal;
a second speed sensor operatively associated with a second output side of the differential, and outputting a second speed signal; and
a circuit responsive the first and second speed signals for indicating a locked or unlocked state of the differential as a function of a difference value between said first and second speed signals.

2. A system according to claim 1 comprising at least one of an acceleration sensor, yaw sensor, or steering wheel angle sensor for providing a driving condition signal, and wherein said circuit indicates a locked or unlocked state of the differential as a function of said driving condition signal.

3. A system according to claim 1 wherein said circuit indicates a locked state of the differential when said difference value is within a predetermined range of values.

4. A system according to claim 1 wherein said circuit indicates a locked state of the differential when said first and second speed signals are substantially equal.

5. A system according to claim 1 wherein said first speed sensor is operatively associated with a first output shaft of the differential, and said second speed sensor is operatively associated with a second output shaft of the differential.

6. A system according to claim 1 wherein said differential comprises a housing having a driven cam located on said first output side, a drive cam associated with an engagement plate fixed to a first output shaft, and an actuating mechanism for selectively coupling said drive cam and said driven cam.

7. A system according to claim 6 wherein said actuating mechanism comprises at least one of a solenoid, pressure plate actuation device, hydraulic actuated device or pneumatic actuation device.

8. A system for determining the locked or unlocked state lo of a differential, comprising:
an actuating mechanism engaged to a drive cam of the differential and adapted to move the drive cam between a locked and unlocked position; and
a sensing system adapted to sense source characteristics to the actuating mechanism and indicate a locked or unlocked state of the differential as a function of said source characteristics.

9. A system according to claim 8 wherein said actuating mechanism comprises at least one of a solenoid, pressure plate actuation device, hydraulic actuated device or pneumatic actuation device.

10. A system according to claim 8 wherein said differential comprises a housing having a driven cam located on said first output side, and wherein said drive cam is associated with an engagement plate fixed to a first output shaft.

11. A system according to claim 8 wherein said actuating mechanism comprises a solenoid and said source characteristic comprises a voltage or current signal.

12. A system according to claim 8 wherein said actuating mechanism comprises a hydraulic actuated device and said source characteristic comprises a pressure or flow signal.

13. A system according to claim 8 wherein said actuating mechanism comprises a pneumatic actuated device and said source characteristic comprises a pressure or flow signal.

14. A system according to claim 8 wherein said sensing system comprises a controller having a memory and programmed to indicate a locked or unlocked state of the differential by comparing said sensed source characteristics to at least one stored value.

15. A system according to claim 14 wherein said sensing system compares said source characteristics to a lookup table of stored characteristic values.

16. A system according to claim 10 comprising a second output shaft and first and second speed sensors operatively associated with said first and second output shafts and indicating first and second speed signals, respectively, and wherein said sensing system is responsive to the first and second speed signals for indicating a locked or unlocked state of the differential as a function of a difference value between said first and second speed signals.

17. A system according to claim 8 comprising at least one of an acceleration sensor, yaw sensor, or steering wheel angle sensor for providing a driving condition signal, and wherein said sensing system indicates a locked or unlocked state of the differential as a function of said driving condition signal.

18. A system for determining the locked or unlocked state of a differential, comprising:
an actuating mechanism engaged to a drive cam of the differential and adapted to move the drive cam between a locked and unlocked position;
a first speed sensor operatively associated with a first output side of the differential, and outputting a first speed signal;
a second speed sensor operatively associated with a second output side of the differential, and outputting a second speed signal; and
a sensing system adapted to sense source characteristics to the actuating mechanism and responsive the first and second speed signals for indicating a locked or unlocked state of the differential as a function of said source characteristics and a difference value between said first and second speed signals.

19. A system according to claim 18 comprising at least one of an acceleration sensor, yaw sensor, or steering wheel angle sensor for providing a driving condition signal, and wherein said sensing system indicates a locked or unlocked state of the differential as a function of said driving condition signal.

20. A system according to claim 18 wherein said actuating mechanism comprises at least one of a solenoid, pressure plate actuation device, hydraulic actuated device or pneumatic actuation device.
